(19) United States
(12) Patent Application Publication
(10) Pub. No.: US 2004/0004577 A1
(43) Pub. Date: Jan. 8, 2004

(54) Flexible curtain antenna for reading RFID tags

(76) Inventor: Ian J. Forster, Essex (GB)

Correspondence Address: WITHROW & TERRANOVA, P.L.L.C., P.O. BOX 1287, CARY, NC, 27512, US

(21) Appl. No.: 10/422,610

(22) Filed: Apr. 24, 2003

Related U.S. Application Data
(60) Provisional application No. 60/376,605, filed on Apr. 29, 2002.

(51) Int. Cl. H01Q 7/00; H01Q 1/52

(52) U.S. Cl. 343/866; 343/841; 343/767

(57) ABSTRACT

A flexible curtain antenna comprised of one or more panels containing at least one conductor antenna. The conductors in the panels are coupled to a transmission device, such as an interrogation reader, to form an antenna. The panels are attached to a mounting structure. The curtain antenna is designed so that objects can pass through the panels. As objects containing wireless communication devices pass through the panels, the panels come into close proximity to the wireless communication devices on the objects. The interrogation reader uses the panels as antennas to establish communication with the wireless communication devices on the objects to retrieve information about the objects. This information can be further communicated to a reporting system and/or a remote system using either a wired or wireless connection.

### RELATED APPLICATIONS

This application claims priority and the benefit of U.S. Provisional Patent Application Serial No. 60/376,605 filed Apr. 29, 2002, which is incorporated by reference herein in its entirety.

### FILED OF THE INVENTION

The present invention relates to a flexible curtain antenna that is coupled to an interrogation reader for communicating with wireless communication devices.

### BACKGROUND OF THE INVENTION

It is commonplace to track objects, such as goods or other articles of manufacture, during their manufacture, transport and/or distribution. Wireless communication devices may be attached to or associated with such objects to provide information about the objects such as their identification number, expiration date, date of manufacture or “born on” date, lot number, and the like.

In order to communicate with a wireless communication device, an interrogation reader or other wireless transmission device must be placed in the transportation path of the objects. An interrogation reader uses an antenna to generate a radiation field for communication with the wireless communication device. If the wireless communication device is designed to operate at short range, the interrogation reader's antenna must be placed in close proximity to the wireless communication device associated with the objects without blocking the transportation path of the objects.

It may be even more difficult to provide an antenna for communication with wireless communicating devices on objects if the wireless communication device is capable of being placed on different areas of the object. For example, a wireless communication device attached to a box may be attached on any face of the box, including the top, bottom, front, back, left or right side.

Therefore, a need exists to provide an antenna for an interrogation reader that can be placed in close proximity to wireless communication devices associated with objects for retrieving information about such objects without interfering or blocking the transportation path of such objects. A need also exists for such antenna to be capable of communicating with wireless communication devices attached on different areas of an object.

### SUMMARY OF THE INVENTION

The present invention is a flexible curtain antenna that is capable of communicating with a wireless communication device on an object passing through the antenna. The curtain antenna contains one or more panels that contain one more conductors to form an antenna. The panels are attached to a mounting structure. The interrogation reader is coupled to the panels to form an antenna to establish communication with a wireless communication device on an object as it passes through the panels.

In one embodiment, flexible panels are attached to a horizontal mounting structure, and the panels hang downward. The horizontal mounting structure is attached to a left vertical structure on its left end and a right vertical structure on its right end to form a portal for objects to pass through. The panels contain a loop conductor that is coupled to the interrogation reader to form an antenna.

In another embodiment, the curtain antenna is designed to allow a forklift truck carrying pallets and/or objects containing wireless communication devices to pass through. The curtain antenna is used by the interrogation reader to communicate with the wireless communication device on the objects.

In another embodiment, the panels of the curtain antenna contain conductors with more than one loop to form multiple loop conductor antennas.

In another embodiment, the panels of the curtain antenna contain a link chain that provides the conductor antenna.

In another embodiment, the mounting structure for wedge-shaped panels is comprised of two vertical supports. The wedge-shaped panels contain antennas and are horizontally attached to the inside of each vertical support. The panels form a finger structure with respect to each other so that the panels interlock with each other in their resting position. Objects having wireless communication devices can be interrogated as they come into close proximity or move through the panels.

In another embodiment, the mounting structure for wedge-shaped panels is circular. The wedge-shaped panels contain antennas and are mounted to the inside of the mounting structure. The panels narrow in width as the panels extend to the center of the mounting structure so that the panels interlock with each other in their resting position. Objects having wireless communication devices can be interrogated as they come into close proximity or move through the panels.

In another embodiment, the panels of the curtain antenna are comprised out of a plastic material filled with air or other material that is expelled onto the objects as they pass through the curtain antenna. Air expelled out of the panels causes the panels to hover around objects passing through the curtain antenna thereby reducing drag on the panels. Other material expelled out of the panels onto the products may be desirable for certain applications. For example, the expelled material may be an insecticide placed on food objects that pass through the curtain antenna.

In another embodiment, the interrogation reader is coupled to a multiplexor to control energy coupled to the conductor antennas in the panels. The multiplexor directs energy from the interrogation reader to one panel at a time to cause the loop conductor in the panel to generate a field for communication with a wireless communication device.

In another embodiment, the interrogation reader is coupled to a proximity sensor to detect objects in close proximity and/or passing through the curtain antenna. The interrogation reader excites the conductors in the panels only when an object is detected to conserve energy.

In another embodiment, the antennas in the panels may be used as a proximity sensor, without need for a separate proximity sensor, to detect objects in close proximity and/or passing through the curtain antenna. The interrogation reader excites the conductors in the panels only when an object is detected to conserve energy.

The interrogation reader is capable of communicating information received from wireless communication devices on objects in close proximity or passing through the curtain antenna to a reporting system and/or a remote system. The reporting system may be located in close proximity to the interrogation reader, and the remote system is located remote from the interrogation reader. The interrogation reader may communicate information to the reporting system and/or the remote system using either a wired or wireless connection.

### BRIEF DESCRIPTION OF THE DRAWINGS

FIG. 1 is a schematic diagram of an interrogation reader and wireless communication device system in the prior art;

FIG. 2 is a schematic diagram of one embodiment of a flexible curtain antenna;

FIG. 3 is a schematic diagram of the movement of one panel in the flexible curtain antenna illustrated in FIG. 2;

FIG. 4 is a schematic diagram of a forklift truck that is transporting stacked pallets containing wireless communication devices through a flexible curtain antenna;

FIG. 5 is a schematic diagram of a flexible curtain antenna comprised of panels having a loop conductor antenna with more than one turn;

FIG. 6 is a schematic diagram of a flexible curtain antenna comprised of panels containing more than one loop conductor antenna;

FIG. 7 is a schematic diagram of a flexible curtain antenna comprised of panels containing a link chain conductor antenna;

FIG. 8A is a schematic diagram of a flexible curtain antenna with vertical supports;

FIG. 8B is a schematic diagram of an object passing through the curtain antenna illustrated in FIG. 8A;

FIG. 9A is a schematic diagram of a flexible curtain antenna with a circular support;

FIG. 9B is a schematic diagram of objects on an assembly line falling through the curtain antenna illustrated in FIG. 9B;

FIG. 10 is a schematic diagram of an interrogation reader that comprises a multiplexor for managing communications between a plurality of panels having antennas in a flexible curtain antenna;

FIG. 11 is a flowchart of an interrogation reader establishing communication with a wireless communication device when an object is detected;

FIG. 12 is a schematic diagram of panels in a curtain antenna expelling air onto products that pass through the curtain antenna to reduce drag on the panels; and

FIG. 13 is a schematic diagram of a reporting system.

### DETAILED DESCRIPTION OF THE INVENTION

The present invention is directed to a flexible curtain antenna that is capable of communicating with a wireless communication device on an object passing through the antenna. The curtain antenna contains one or more panels that contain one or more conductors to form an antenna. The panels are attached to a mounting structure. The panels are capable of moving relative to the mounting structure as objects pass through the panels. An interrogation reader uses the panels as an antenna to establish communication with a wireless communication device on an object as it passes through the panels.

Before discussing the particular aspects of the curtain antenna, a brief discussion of interrogation readers and wireless communication devices follows.

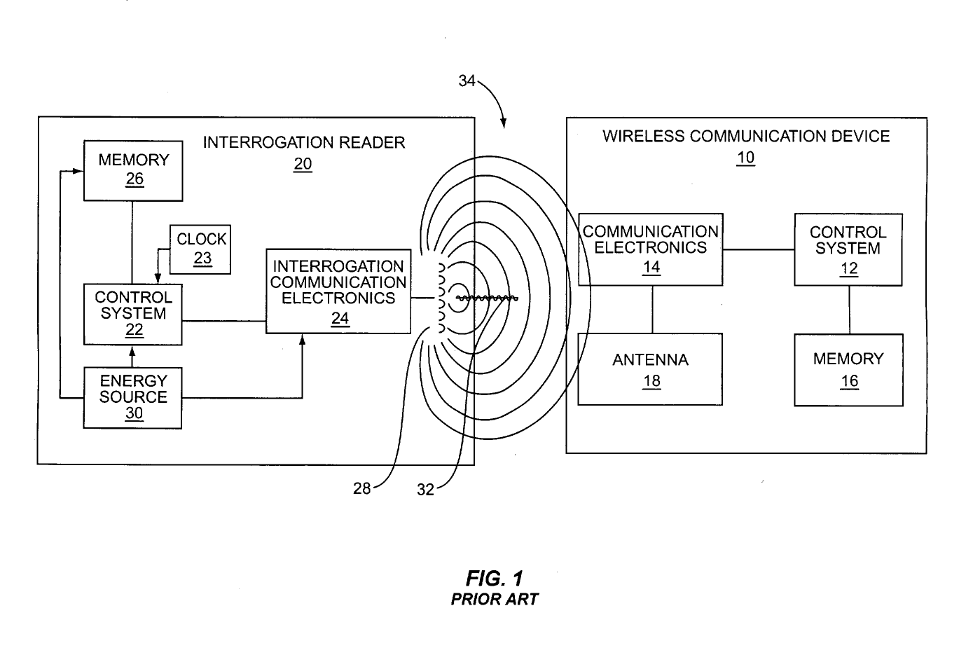

FIG. 1 illustrates a typical wireless communication device and communication system in the prior art. The wireless communication device 10 is capable of communicating information wirelessly and may include a control system 12, communication electronics 14, and memory 16. The wireless communication device 10 is also known as a radio-frequency identification device (RFID). The communication electronics 14 is coupled to an antenna 18 for wirelessly communicating information in radio-frequency signals. The communication electronics 14 is capable of receiving modulated radio-frequency signals through the antenna 18 and demodulating these signals into information passed to the control system 12. The antenna 18 may be internal or external to the wireless communication device 10.

The control system 12 may be any type of circuitry or processor that receives and processes information received by the communication electronics 14, including a micro-controller or microprocessor. The wireless communication device 10 may also contain a memory 16 for storage of information. Such information may be any type of information about goods or objects, including but not limited to identification, tracking and other pertinent information. The memory 16 may be electronic memory, such as random access memory (RAM), read-only memory (ROM), flash memory, diode, etc., or the memory 16 may be mechanical memory, such as a switch, dip-switch, etc.

Some wireless communication devices 10 are termed “active” devices in that they receive and transmit data using their own energy source coupled to the wireless communication device 10. A wireless communication device 10 may use a battery for power as described in U.S. Pat. No. 6,130,602 entitled “Radio frequency data communications device,” or may use other forms of energy, such as a capacitor as described in U.S. Pat. No. 5,833,603, entitled “Implantable biosensing transponder.” Both of the preceding patents are incorporated herein by reference in their entirety.

Other wireless communication devices 10 are termed “passive” devices meaning that they do not actively transmit and therefore may not include their own energy source for power. One type of passive wireless communication device 10 is known as a “transponder.” A transponder effectively transmits information by reflecting back a received signal from an external communication device, such as an interrogation reader. An example of a transponder is disclosed in U.S. Pat. No. 5,347,280, entitled “Frequency diversity transponder arrangement,” incorporated herein by reference in its entirety. Another example of a transponder is described in co-pending patent application Ser. No. 09/678,271, entitled “Wireless communication device and method,” incorporated herein by reference in its entirety.

It is readily understood to one of ordinary skill in the art that there are many other types of wireless communications devices and communication techniques than those described herein, and the present invention is not limited to a particular type of wireless communication device, technique or method.

FIG. 1 also depicts communication between a wireless communication device 10 and an interrogation reader 20. The interrogation reader 20 may include a control system 22, an interrogation communication electronics 24, memory 26, and an interrogation antenna 28. The interrogation antenna 28 may be a pole antenna or a slot antenna. The interrogation reader 20 may also contain its own internal energy source 30, or the interrogation reader 20 may be powered through an external power source (not shown). The energy source 30 may include a battery, a capacitor, solar cell or other medium that contains energy. The energy source 30 may also be rechargeable. The interrogation reader 20 may also include a clock 23 that is coupled to and used by the control system 22 for changing clock cycles and timing operations and/or other timing calculations.

The interrogation reader 20 communicates with the wireless communication device 10 by emitting an electronic communication signal 32 modulated by the interrogation communication electronics 24 through the interrogation antenna 28. The interrogation antenna 28 may be any type of antenna that can radiate a communication signal 32 through a field 34 so that a reception device, such as a wireless communication device 10, can receive such communication signal 32 through its own antenna 18. The field 34 may be electromagnetic, magnetic, or electric. The communication signal 32 may be a message containing information and/or a specific request for the wireless communication device 10 to perform a task or communicate back information. When the antenna 18 is in the presence of the field 34 emitted by the interrogation reader 20, the communication electronics 14 are energized by the energy in the communication signal 32, thereby energizing the wireless communication device 10. The wireless communication device 10 remains energized so long as its antenna 18 is in the field 34 of the interrogation reader 20. The communication electronics 14 demodulates the communication signal 32 and sends the message containing information and/or request to the control system 12 for appropriate actions.

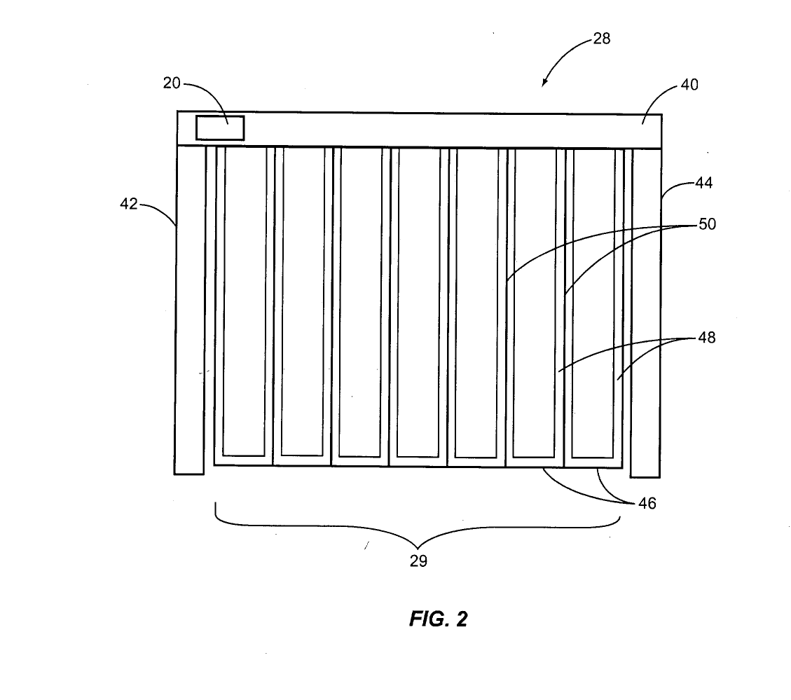

FIG. 2 illustrates a curtain antenna 28 for one embodiment of the present invention. The curtain antenna 28 is comprised of a horizontal mounting structure 40. The horizontal mounting structure 40 may be comprised out of any sturdy material, including but not limited to metal, steel, aluminum, plastic, etc. The curtain antenna 28 is also comprised of a left vertical structure 42 and a right vertical structure 44. The left vertical structure 42 and the right vertical structure 44 are attached substantially perpendicular to the horizontal mounting structure 40 on each of its ends to form an opening or portal 29. Please note, however, that the left vertical structure 42 and right vertical structure 44 are optional and are not required to practice the present invention.

Objects containing wireless communication devices 10 pass through the portal 29, and the curtain antenna 28 is excited by the interrogation reader 20 to communicate with the wireless communication devices 10. Objects may include, but are not limited to, a container, a pallet, a beverage can, and a beer keg. More information on wireless communication devices 10 attached to the aforementioned objects is disclosed in co-pending patent application Ser. No. 09/678,271 filed on Oct. 3, 2000 entitled “Wireless communication device and method,” incorporated herein by reference in its entirety.

The wireless communication device 10 and the curtain antenna 28 may be designed to operate at lower frequencies such as 125 kHz and 13.56 MHz, or higher frequencies such as 2.45 GHz. The curtain antenna 28 may also be comprised of antennas that are designed to communicate at different frequencies so that the same curtain antenna 28 is capable of communicating with wireless communication devices 10 that operate at different frequencies, or a single wireless communication device 10 that is capable of operating at more than one frequency.

The curtain antenna 28 has one or more panels 46 that are attached to the horizontal mounting structure 40 between the left vertical structure 42 and the right vertical structure 44. Just as the left vertical structure 42 and the right vertical structure 44, the panels 46 are also attached substantially perpendicular to the horizontal mounting structure 40 on one end. However, unlike the left vertical structure 42 and the right vertical structure 44, the panels 46 are flexible. The panels 46 may be comprised out of any flexible material, including but not limited to plastic, rubber, etc. The curtain antenna 28 is designed so that an object can pass through the portal 29 and through the panels 46. The panels 46 move when the object passes through the portal 29. The panels 46 drape around the object as it passes through the portal 29 since the tendency of the panels 46 is to move back to their uninterrupted position; hanging straight down.

In this embodiment, there are seven panels 46 aligned side-by-side in the curtain antenna 28. Increasing the number of panels 46 allows an object to place less force on the panels 46 for the object to move through the panels 46 since the width and the weight of the individual panels 46 is less. A small gap 50 may exist between each panel 46 so that the panels 46 are free to move about when encountering an object.

The panels 46 contain a conductor 48 that forms an antenna as part of the curtain antenna 28. The conductor 48 may be a wire and may be comprised out of any conductive material, including but not limited to aluminum, copper, and steel. The interrogation reader 20 is coupled to one or more conductors 48 in the panels 46 so that the conductors 48 generate the field 34 for communications with wireless communication devices 10 that pass through the portal 29 and/or come in close proximity to the panels 46.

The conductor 48 that forms the curtain antenna 28 may be any type of pole antenna, including a loop conductor or dipole antenna. The panels 46 may also contain any type of slot antenna that acts as the curtain antenna 28. Examples of pole and slot antennas that may be used with the present invention are disclosed in co-pending patent application Ser. No. 09/810,858 entitled “Communicating with stackable objects using an antenna array,” filed on Mar. 16, 2001, incorporated herein by reference in its entirety.

The interrogation reader 20 may be attached to any component of the curtain antenna 28, such as the horizontal mounting structure 40 as illustrated in FIG. 2. However, the interrogation reader 20 does not have to be attached to the curtain antenna 28.

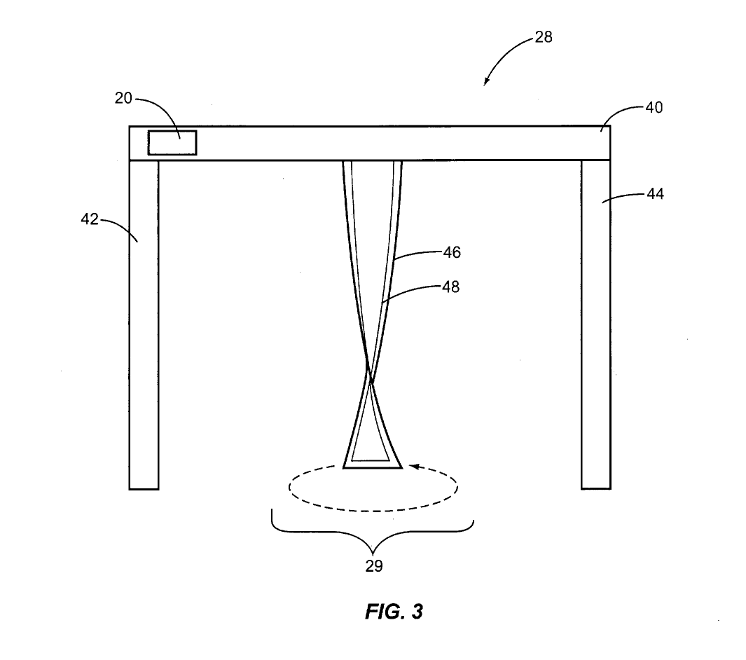

FIG. 3 illustrates a curtain antenna 28 like that illustrated in FIG. 2, except that only one panel 46 is shown to illustrate the movement of the panel 46. Because the panel 46 is attached only to one end of the horizontal mounting structure 40, the panel 46 is free to move about this point of connection. The panel 46 will move in a conical direction with respect to the horizontal mounting structure 40 when force is applied to the panel 46 such as when an object comes in contact with the panel 46 as it encounters and passes through the portal 29. The point at which the panel 46 attaches to the horizontal mounting structure 40 is the smallest portion of the conical shape, and the end of the panel 46 that does not attach to the horizontal mounting structure 40 forms the largest area of the conical shape.

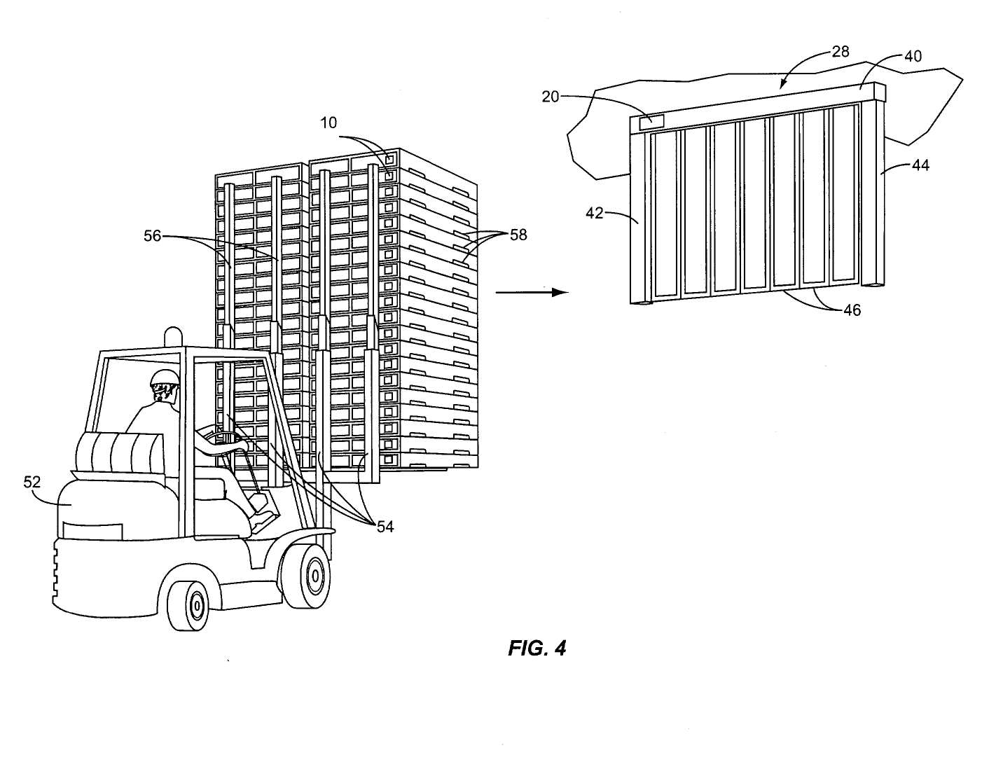

FIG. 4 illustrates one application for the curtain antenna 28 to be used for communication with wireless communication devices 10 passing through the portal 29 of the curtain antenna 28. A forklift truck 52 contains one or more pallets 58 that contain wireless communication devices 10. The wireless communication device 10 may contain information about the pallet 58 to which it is attached, such as its identification. The interrogation reader 20 communicates with the wireless communication devices 10 on the pallets 58 to retrieve this information. The forklift truck 52 has static arms 54 and moveable arms 56. The pallets 58 are stacked on the moveable arms 56, and the moveable arms 56 can be raised or lowered by the forklift truck 52 for raising or lowering the pallets 58 for transport and/or storage.

More information on the tracking of pallets 58 and/or objects on pallets 58 containing wireless communication devices 10 is discussed on co-pending patent application Ser. No. 09/810,858, referenced above, and incorporated herein by reference in its entirety. Also note that other transportation devices may include objects containing wireless communication devices 10 that may pass through the portal 29, including but not limited to a crane, an automobile, and a motorcycle.

In the present invention, the curtain antenna 28 may be designed to allow the forklift truck 52 containing one or more pallets 58 to pass through the portal 29 so that the curtain antenna 28 can communicate with the wireless communication devices 10 on the pallets 58. Since the panels 46 are flexible, a forklift truck 52 with its cargo can pass through the portal 29 so long as the forklift truck 52 and its cargo is smaller in dimension than the portal 29. When the forklift truck 52 and its pallets 58 move through the portal 29, the panels 46 move about the pallets 58. The interrogation reader 20 causes the conductors 48 inside the panels 46 to generate a field 34 that is received by the wireless communication devices 10 on the pallets 58. In this manner, the panels 46 act as the antenna 28 to allow the interrogation reader 20 to communicate with the wireless communication devices 10 on the pallets 58 as the pallets 58 pass through the portal 29. The panels 46 may also be transparent or substantially transparent so that the operator of the forklift truck 52 can see through the curtain antenna 28 before driving through the portal 29.

The panels 46 that are in the direct path of the pallets 58 passing through the portal 29 will first encounter the front of the pallets 58, and then move up and drape over the top of the pallets 58 as they pass through. As the pallets 58 move fully through the portal 29, the panels 46 will fall down on the backside of the pallets 58. In this manner, the pallets 58 in the direct path of the panels 46 will either contact or come into close proximity to the front, top and back of the pallets 58 and any wireless communication devices 10 attached on the front, top, and back of the pallets 58.

Preferably, the portal 29 is designed to be large enough so that panels 46 are present in both the direct path and adjacent to the pallets 58 or other objects as they pass through the portal 29 so that the curtain antenna 28 can communicate with any wireless communication devices 10 on the sides of the pallets 58. The panels 46 that are located immediately adjacent to the left side and right side of the pallets 58 passing through the portal 29 will not encounter the front, top, and back of the pallets 58. Instead, these panels 46 will either come into contact or close proximity to the left side and right side of the pallets 58 so that any wireless communication devices 10 located on the left side or right side of the pallets 58 come into contact with the field 34 generated by these panels 46. The curtain antenna 28 is designed so that there is a substantial likelihood that any objects that pass through the portal 29 having wireless communication devices 10 at any location on the object will be interrogated successfully.

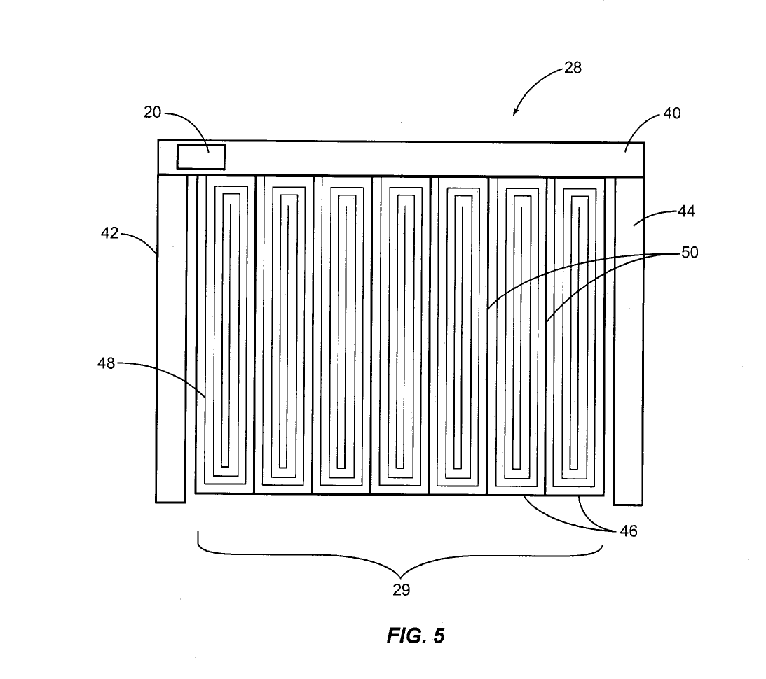

FIG. 5 illustrates a curtain antenna 28 similar to that illustrated in FIG. 2; however, the conductors 48 in the panels 46 contain one or more turns to form the loop antenna. A number of turns are placed in the conductor 48 to provide the correct length for the desired operating frequency of the curtain antenna 28.

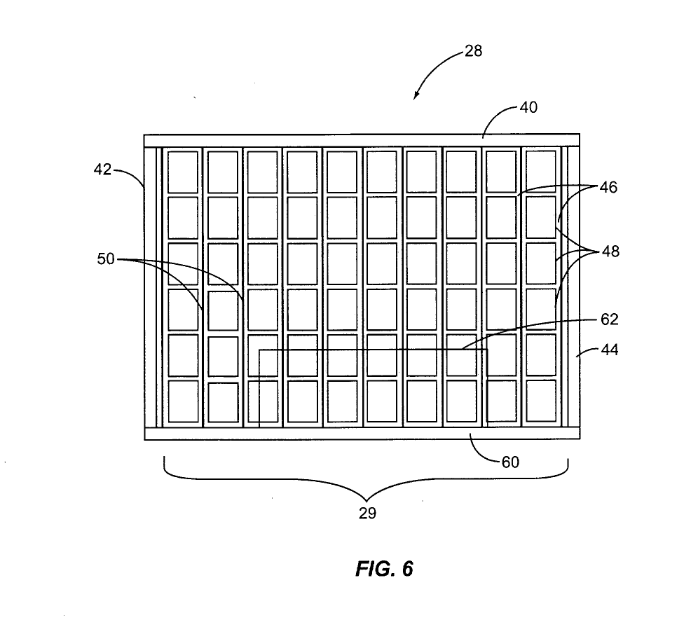

FIG. 6 illustrates another embodiment of the curtain antenna 28 that is again similar to that described and illustrated in FIG. 2. However, in this embodiment, the panels 46 each contain multiple loop conductors 48 with each individual loop conductor 48 capable of operating as an antenna. This essentially turns each panel 46 into a multi-antenna configuration so that wireless communication devices 10 can be interrogated by any one of the loop conductors 48. Use of more than one loop conductor 48 in panels 46 may allow the curtain antenna 28 to better communicate with wireless communication devices 10 that pass in close proximity to the panels 46 and/or pass through the portal 29.

Not all of the loop conductors 48 will establish communication with wireless communication devices 10 passing through the portal 29. The size of the object that passes through the portal 29 will determine how the loop conductors 48 establish communications with a wireless communication device 10 associated with the object. In this embodiment, an assembly line 60 transports objects through the portal 29. An object of a first size 62 may pass through the portal 29. Note that the loop conductors 48 in the path of the object of the first size 62 contact the object causing cross coupling with other loop conductors 48 adjacent to those in the path of the object of the first size 62. This cross coupling may be used by the interrogation reader 20 to determine the height, width and other shape information about the object passing through the portal 29. The tuning, via the performance, of the loop conductors 48 may be examined by the interrogation reader 20 during transmission, and a profile of the metal content of the object may also be determined.

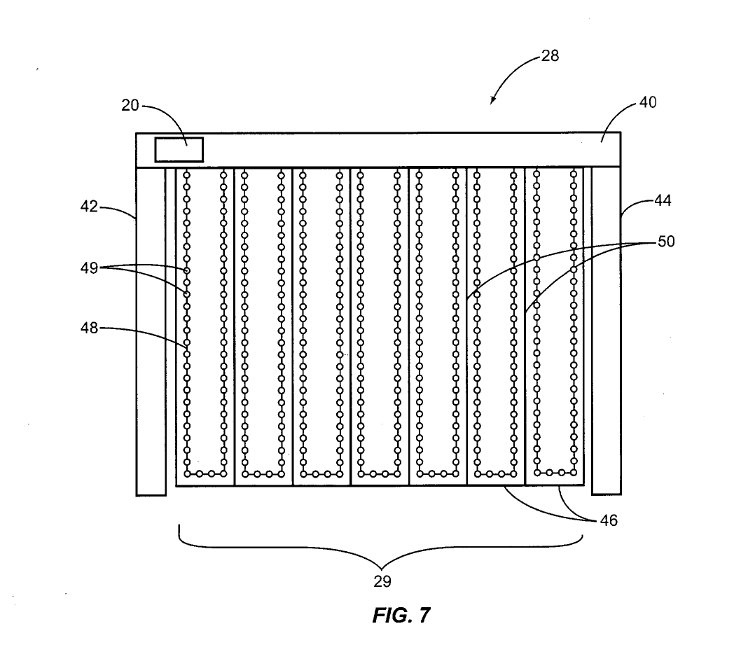

FIG. 7 illustrates another type of conductor 48 that may be provided in the curtain antenna 28. The conductor 48 is comprised out of a link chain 48 instead of a conductor wire. The links 49 in the link chain 48 may be constructed out of any conductive material so long as an electrical connection can be made between the interrogation reader 20 and the link chain 48 to provide the antenna 28. The use of a link chain 48 may be advantageous due to its increased strength over a wire conductor. As objects move through the portal 29 over a long period of time, a wire conductor may become weakened and eventually break. This break may disconnect the interrogation reader 20 from the wire conductor so that a particular panel 46 no longer generates a field 34. Or, the break may cause the wire conductor to differ from the designated length such that the resonant frequency of the conductor 48 in a panel 46 is not the same as wireless communication devices 10 passing through the portal 29. In either case, the panel 46 will not be operational to generate the designed field 34 to form part of the curtain antenna 28.

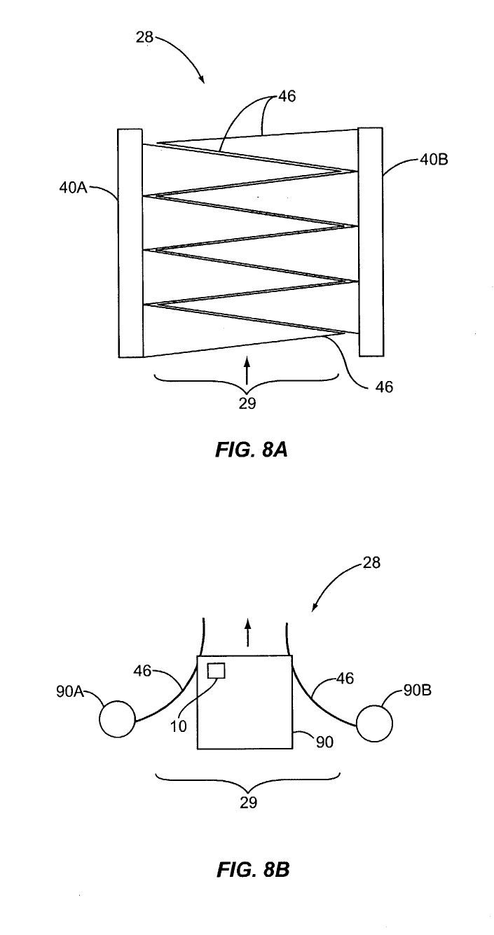

FIG. 8A illustrates another embodiment of the curtain antenna 28 wherein the mounting structure is comprised of two vertical mounting structures 40A, 40B. The mounting structures 40A, 40B are aligned apart from each other to form the portal 29. The panels 46 are attached to the insides of the mounting structures 40A, 40B and extend horizontally rather than vertically, as illustrated in FIG. 2. In this embodiment of FIG. 8A, panels 46 are attached to each mounting structure 40A, 40B facing inward towards the opposite mounting structure 40A, 40B. The panels 46 are wedge-shaped so that the panels 46 can interlock with each other so that the portal 29 area between the mounting structures 40A, 40B is substantially covered with panels 46. It is more likely that a wireless communication device 10 passing through the portal 29 and the panels 46 will encounter the field 34 of the interrogation reader 20 if the panels 46 substantially cover the portal 29 area.

The panels 46 contain conductors 48 (not shown) or other antennas that act as the curtain antenna 28 coupled to the interrogation reader 20. The panels 46 located adjacent to each other but attached to opposite mounting structures 40A, 40B are offset from in each other in height where they are attached to the mounting structures 40A, 40B so that the panels 46 form interlocking fingers with each other.

FIG. 8B illustrates an object 90 passing through the curtain antenna 28 illustrated in FIG. 8A. As the object 90 encounters the panels 46, the panels 46, being flexible, bend outward from their respective mounting structures 40A, 40B. The panels 46 have a resiliency so that they tend to move back into their initial resting position, as illustrated in FIG. 8A, when not under a force. As the object 90 exerts a force on the panels 46, the panels 46 run along the outside edges of the object 90 and move across the entire depth of the object 90. In this manner, the interrogation reader 20 is capable of interrogating any wireless communication device 10 associated with the objects 90 that either comes into close proximity to the panels 46 or physically encounters the panels 46 as the object 90 moves through the panels 46.

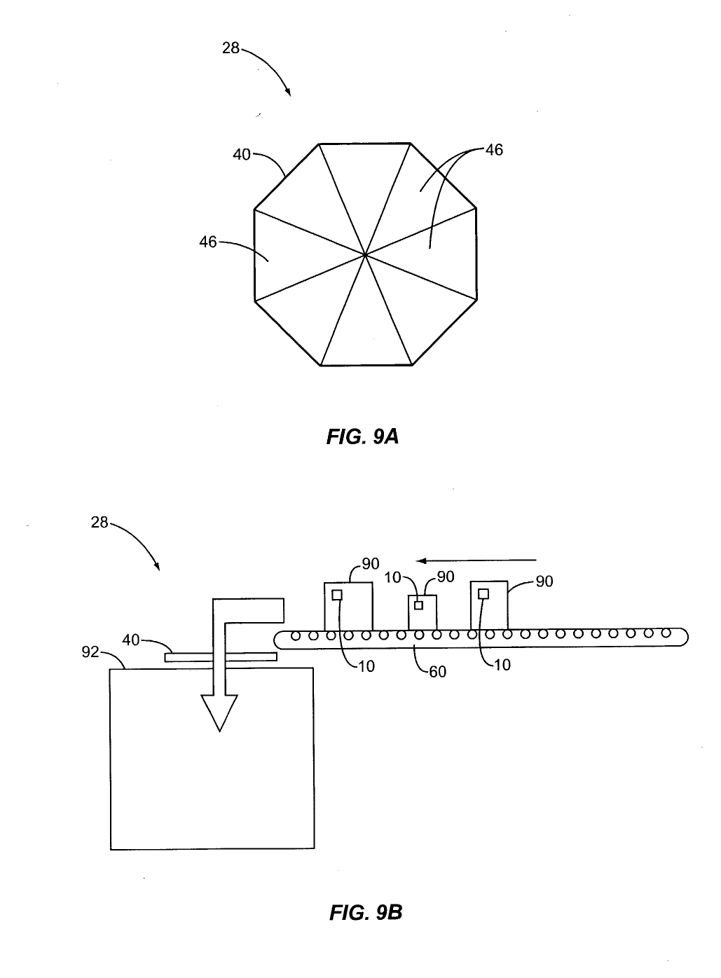

FIG. 9A illustrates another embodiment of the curtain antenna 28 wherein the mounting structure is comprised of a circular-shaped mounting structure 40 that is a closed shape. In this embodiment, the mounting structure 40 is actually octagonal in shape. The panels 46 are attached to the inside edges of the mounting structure 40 and extend inward to the center of the octagonal shape comprising the mounting structure 40. The panels 46 are wedge-shaped so that the panels 46 interlock with each other as the panels 46 extend inward to the center of the octagonal shape comprising the mounting structure 40. The panels 46 contain conductors 48 (not shown) or other antennas that act as the curtain antenna 28 coupled to the interrogation reader 20.

FIG. 9B illustrates an object 90 with associated wireless communication device 10 that is moving on an assembly line 60. The object 90 moves to the end of the assembly line 60 and falls through the curtain antenna 28 (shown in side view) into a container 92 as illustrated in FIG. 9A. As the object 90 encounters the panels 46, the panels 46, being flexible, bend downward from the mounting structure 40 towards the ground. The panels 46 have a resiliency so that they tend to move back upward into their initial resting position, as illustrated in FIG. 9A, when not under a force. As the object 90 exerts a force on the panels 46, the panels 46 run along the outside edges of the object 90 and move across the entire height of the object 90. In this manner, the interrogation reader 20 is capable of interrogating any wireless communication device 10 associated with the object 90 that either comes into close proximity to the panels 46 or physically encounters the panels 46 as the object 90 moves through the panels 46.

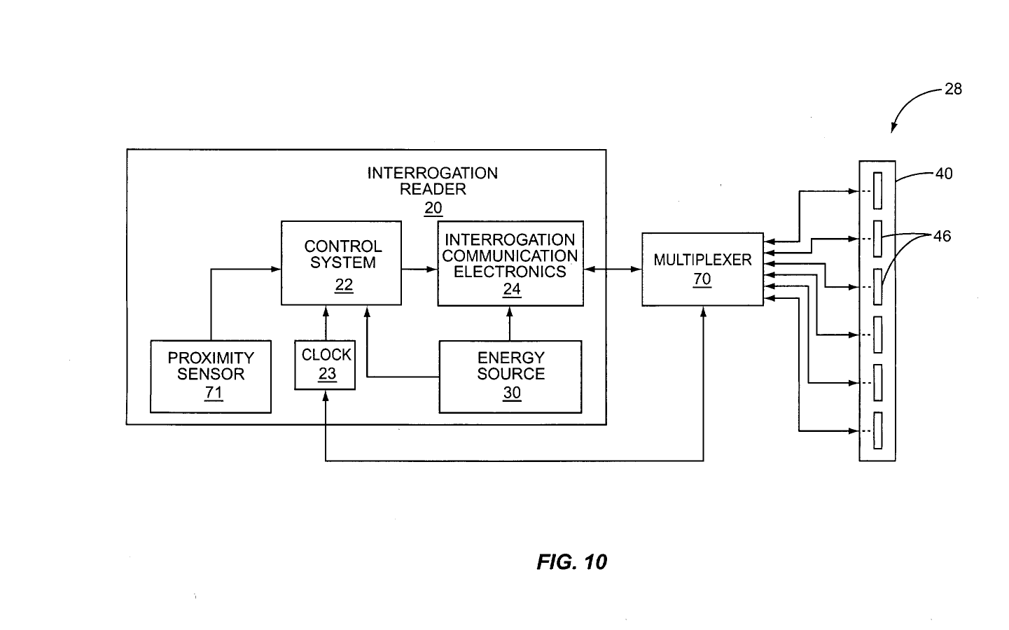

FIG. 10 illustrates a block diagram of a multiplexor 70 used with the interrogation reader 20 so that communications between the interrogation reader 20 and multiple panels 46 in the curtain antenna 28 can be managed individually. In this manner, the interrogation reader 20 only excites one panel 46 and its associated conductor 48 (not shown) at a time so that multiple fields 34 are not generated, which would potentially cause any wireless communication devices 10 to respond to more than one field 34.

A multiplexor 70 is provided between the interrogation communication electronics 24 and each of the conductors 48 in the panels 46 of the curtain antenna 28. For the example illustrated in FIG. 10, the multiplexor 70 chosen is an eight state multiplexor since there are six panels 46 in the curtain antenna 29, and each panel 46 has only a single conductor 48. Two states of the multiplexor 70 will be unused. The clock 23 is coupled to the multiplexor 70 to cause the multiplexor 70 to cycle states creating a conductive connection or coupling between the interrogation communication electronics 24 and only one of the six conductors 48 corresponding to the six panels 46 at a time. The multiplexor 70 cycles states in a sequential fashion so that the conductor 48 in the first panel 46 is conductively connected or coupled to the interrogation communication electronics 24. The conductor 48 in the second panel 46 is next coupled to the interrogation communication electronics 24, and so forth, until each conductor 48 in the panels 46 has been conductively connected or coupled to the interrogation communication electronics 24. The multiplexor 70 repeats by cycling through its states again, providing a conductive connection or coupling between the conductors 48 and the interrogation communication electronics 24.

Preferably, the clock 23 is of a speed that cycles the multiplexor 70 fast enough so that all of the panels 46 and their associated conductors 48 are conductively connected or coupled to the interrogation communication electronics 24 at least several times as an object passes through the portal 29.

FIG. 10 also illustrates a proximity sensor 71 coupled to the control system 22 of the interrogation reader 20. The interrogation reader 20 may be configured to only excite the conductors 48 in the curtain antenna 28 when an object is detected in close proximity and/or passing through the portal 29. This allows the interrogation reader 20 to only expend energy exciting the conductors 48 in the panels 46 when an object is detected. This also allows the interrogation reader 20 to conserve energy from its energy source 30. In addition to the cost savings associated with conservation of power, use of a proximity sensor 71 to only interrogate when an object is detected may be of particular importance if the energy source 30 is a non-renewable energy source, such as a battery, since it can be time consuming to replace non-renewable energy sources, such as batteries.

Any type of proximity sensor 71 may be used in the interrogation reader 20 to detect objects. Examples of proximity sensors that may be used with the present invention are disclosed in U.S. Pat. Nos. 5,675,173; 5,877,664; 5,880,538; and 5,675,150, all of which are incorporated herein by reference in their entirety.

The proximity sensor 71 may be located in the interrogation reader 20 or in close proximity to the interrogation reader 20. The proximity sensor 71 may be located on or near the curtain antenna 28 in a position that allows detection of an object before or during its passage through the portal 29 of the curtain antenna 28. In this manner, the control system 22 can cause the interrogation communication electronics 24 to excite the panels 46 and their associated conductors 48 to communicate with any wireless communication devices 10 associated with the objects passing through the portal 29.

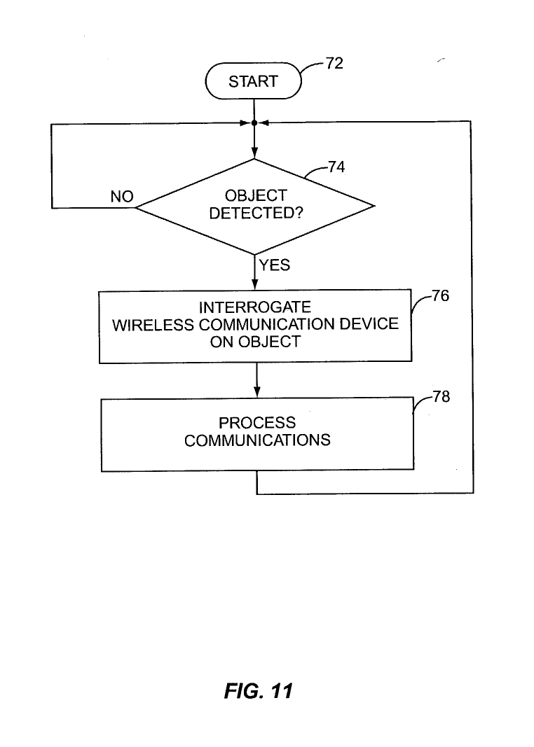

FIG. 11 illustrates a flowchart of the process used by the control system 22 to interrogate only when objects are detected using the proximity sensor 71. The process starts (block 72), and the control system 22 determines if an object has been detected using the proximity sensor 71 (decision 74). If not, the process repeats in a looping fashion with the control system 22 again determining whether an object has been detected (decision 74). If an object is detected, the control system 22 causes the interrogation communication electronics 24 to excite the conductors 48 in the panels 46 to generate the field 34 (block 76). The interrogation reader 20 then processes any communications received from a wireless communication device 10 (block 78). The process repeats with the control system 22 detecting any additional objects coming in close proximity to the curtain antenna 28 and/or passing through the portal 29 (decision 74) so that the interrogation reader 20 continues to interrogate the wireless communication devices 10 on newly encountered objects.

The proximity sensing capability of the interrogation reader 20 may also be performed without the need for a separate proximity sensor 71. For example, the interrogation reader 20 may constantly excite the curtain antenna 28 with a power signal. To conserve power, a low energy power signal may be used, such as 1 milliWatt for example. The interrogation reader 20 is capable of detecting an object by detecting a mismatch of the curtain antenna 28 caused by an object detuning the curtain antenna 28 for the action taken in decision 74 illustrated in the flowchart in FIG. 11. When the interrogation reader 20 detects an object, the interrogation reader 20 then excites the curtain antenna 28 with a higher power signal, such as 1 Watt for example, so that it can establish communications with any wireless communication device 10 associated with the object. Examples of using antennas that may be used as proximity sensors with the present invention are disclosed in co-pending patent application Ser. No. 08/810,858, referenced above, and incorporated herein by reference in its entirety.

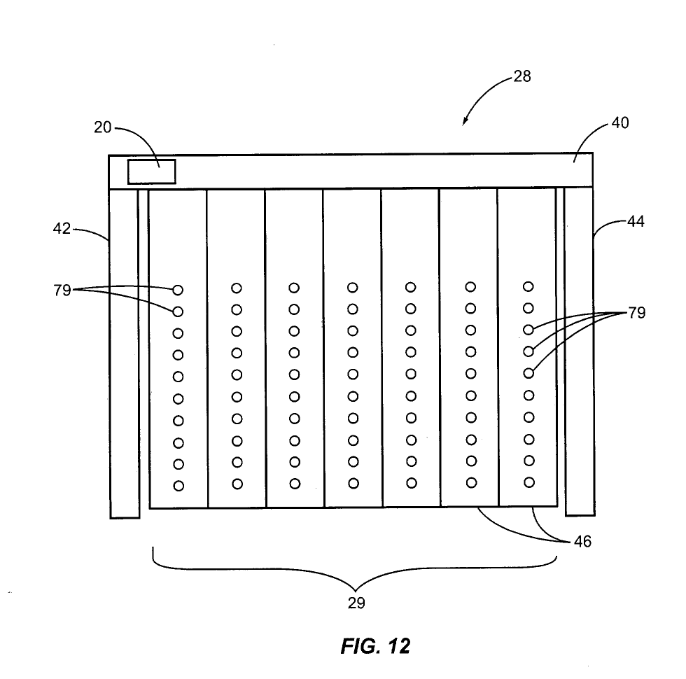

FIG. 12 illustrates a curtain antenna 28 that contains panels 46 configured to exert air onto objects as they pass through the portal 29. Exerting air onto the objects as they pass through the portal 29 will reduce the amount of contact force that the panels 46 exert on the objects in case the objects are fragile, such as fruits for example. In this embodiment, the panels 46 are constructed out of plastic and are filled with pressurized air. A pressurized air source (not shown) under control of the interrogation reader 20 is provided to fill the panels 46 with air. The panels 46 contain one or more holes 79 to exert the pressurized air onto the objects. As objects are detected by the interrogation reader 20, such as by using proximity sensing methods discussed above, the interrogation reader 20 controls the pressurized air source to force air into the panels 46 and out of the holes 79 onto the objects. In this manner, the air is exerted onto the objects as they pass through the portal 29, causing the panels 46 to hover on top of the objects.

The panels 46 may also be configured to exert other desired materials onto the objects as they pass through portal 29, such as a liquid. For example, the interrogation reader 20 may fill the panels 46 with water that is then exerted on food objects as the food objects pass through the portal 29 for cleaning purposes. The liquid could also be an insecticide that is exerted onto food objects to protect the food objects from insects.

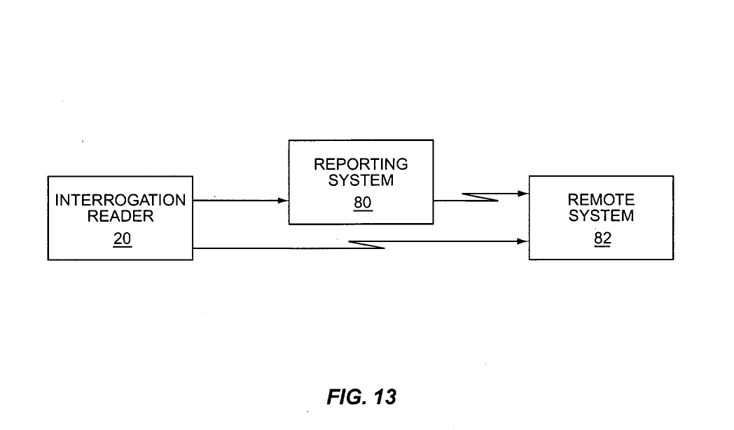

FIG. 13 illustrates a block diagram of an information reporting configuration for the present invention whereby information received by the interrogation reader 20 from wireless communication devices 10 is communicated to other systems. The interrogation reader 20 may be coupled to a reporting system 80. This reporting system 80 may be located in close proximity to the interrogation reader 20, and the reporting system 80 may be coupled to the interrogation reader 20 by either a wired or wireless connection. The reporting system 80 may be a user interface or other computer system that is capable of receiving information about objects with associated wireless communication devices 10. The information may be used to track the objects, display information about the objects and/or to store information concerning the objects in memory (not shown).

The reporting system 80 may also further communicate information from the wireless communication devices 10 to a remote system 82 located remotely from the reporting system 80 and/or the interrogation reader 20. The communication between the reporting system 80 and the remote system 82 may be through wired communication, modem communication or other networking communication, such as the Internet. Alternatively, the interrogation reader 20 may communicate information about the wireless communication devices 10 directly to the remote system 82 rather than first reporting the information through the reporting system 80.

Certain modifications and improvements will occur to those skilled in the art upon a reading of the foregoing description. It should be understood that the present invention is not limited to any particular type of component, including but not limited to the wireless communication device 10 and its components; the interrogation reader 20 and its components; the curtain antenna 28 and its components; including mounting structure 40; left vertical structure 42; right vertical structure 44; panel(s) 46; and conductor(s) 48; the transportation device 52; the assembly line 60; the multiplexor 70; the proximity sensor 71; the reporting system 80; and the remote system 82. For the purposes of this application, couple, coupled, or coupling is defined as either a direct connection or a reactive coupling. Reactive coupling is defined as either capacitive or inductive coupling.

One of ordinary skill in the art will recognize that there are different manners in which these elements can accomplish the present invention. The present invention is intended to cover what is claimed and any equivalents. The specific embodiments used herein are to aid in the understanding of the present invention, and should not be used to limit the scope of the invention in a manner narrower than the claims and their equivalents.

What is claimed is:

1. A curtain antenna capable of communicating with a wireless communication device on an object passing through the antenna, comprising:
a horizontal mounting structure; and
a plurality of panels containing an antenna and hanging from said mounting structure and capable of moving in any direction in a conical area relative to said mounting structure;
said at least one of said plurality of panels is capable of communicating with the wireless communication device and moving about the object as it passes through said plurality of panels.

2. The antenna of claim 1, wherein at least one of said plurality of panels comprises a pole antenna.

3. The antenna of claim 1, wherein at least one of said plurality of panels comprises a slot antenna.

4. The antenna of claim 2, wherein said pole antenna comprises a loop antenna.

5. The antenna of claim 4, wherein said loop antenna has one turn.

6. The antenna of claim 4, wherein said loop antenna has a plurality of turns.

7. The antenna of claim 4, wherein said loop antenna is comprised of a link chain.

8. The antenna of claim 4, wherein said loop antenna comprises more than one loop antenna.

9. The antenna of claim 1, wherein said plurality of panels is comprised of plastic.

10. The antenna of claim 1, wherein said plurality of panels are substantially transparent.

11. The antenna of claim 1, wherein said plurality of panels comprises four or more panels.

12. The antenna of claim 1, wherein said antenna is tuned to radiate energy at frequencies comprised from the group consisting of around about 125 kHz, around about 13.56 MHz, and around about 2.45 GHz.

13. The antenna of claim 1, further comprising a left vertical structure attached to the left side of the horizontal mounting structure and a right vertical structure attached to the right side of the horizontal mounting structure to form a portal for the objects to pass through.

14. A curtain antenna capable of communicating with a wireless communication device on an object passing through the antenna, comprising:
a mounting structure;
a plurality of wedge-shaped panels attached to said mounting structure wherein each of said plurality of wedge-shaped panels contain an antenna and are interlocked with each other in their resting position; and
wherein at least one of said plurality of panels is capable of communicating with the wireless communication device and moving about the object as it passes through said plurality of panels.

15. The antenna of claim 14, wherein at least one of said plurality of wedge-shaped panels comprises a pole antenna.

16. The antenna of claim 14, wherein at least one of said plurality of wedge-shaped panels comprises a slot antenna.

17. The antenna of claim 15, wherein said pole antenna comprises a loop antenna.

18. The antenna of claim 17, wherein said loop antenna has one turn.

19. The antenna of claim 17, wherein said loop antenna has a plurality of turns.

20. The antenna of claim 17, wherein said loop antenna is comprised of a link chain.

21. The antenna of claim 17, wherein said pole antenna comprises more than one loop antenna.

22. The antenna of claim 14, wherein said plurality of wedge-shaped panels is comprised of plastic.

23. The antenna of claim 14, wherein said plurality of wedge-shaped panels are substantially transparent.

24. The antenna of claim 14, wherein said plurality of wedge-shaped panels comprises four or more panels.

25. The antenna of claim 14, wherein said antenna is tuned to radiate energy at frequencies comprised from the group consisting of around about 125 kHz, around about 13.56 MHz, and around about 2.45 GHz.

26. An interrogation system for interrogating a wireless communication device on an object, comprising:
an antenna, comprising a plurality of panels hanging from a horizontal mounting structure, said plurality of panels capable of moving in any direction in a conical area relative to said horizontal mounting structure; and
an interrogation reader coupled to said antenna to allow at least one of said plurality of panels to communicate with the wireless communication device and move about the object as it passes through said plurality of panels.

27. The system of claim 26, wherein said interrogation reader is adapted to receive communications at more than one frequency from the wireless communication device.

28. The system of claim 26, wherein said interrogation reader detects a mismatch in one of said plurality of panels when the object comes into close proximity to said one of said plurality of panels wherein said interrogation reader communicates with the wireless communication device on the object when said proximity sensor detects the object.

29. The system of claim 26, further comprising a proximity sensor coupled to said interrogation reader wherein said interrogation reader communicates with the wireless communication device on the object when said proximity sensor detects the object.

30. The system of claim 26, wherein at least one of said plurality of panels comprises a pole antenna.

31. The system of claim 26, wherein at least one of said plurality of panels comprises a slot antenna.

32. The system of claim 30, wherein said pole antenna comprises a loop antenna.

33. The system of claim 32, wherein said loop antenna has one turn.

34. The system of claim 32, wherein said loop antenna has a plurality of turns.

35. The system of claim 32, wherein said loop antenna is comprised of a link chain.

36. The system of claim 32, wherein said loop antenna comprises more than one loop antenna.

37. The system of claim 26, wherein said plurality of panels is comprised of plastic.

38. The system of claim 26, wherein said plurality of panels are substantially transparent.

39. The system of claim 26, wherein said plurality of panels comprises eight or more panels.

40. The system of claim 26, wherein said antenna is tuned to radiate energy at frequencies comprised from the group consisting of around about 125 kHz, around about 13.56 MHz, and around about 2.45 GHz.

41. The system of claim 26, wherein the communications received by said plurality of panels from said wireless communication device are multiplexed into said interrogation reader.

42. The system of claim 26, wherein said interrogation reader communicates with said wireless communication device to obtain information about the object.

43. The system of claim 42, wherein said information is comprised from the group consisting of the object size, height, width, metal content, identification, date of manufacture, lot number, and expiration date.

44. The system of claim 26, further comprising a reporting system that receives communication from said interrogation reader interrogated by said interrogation reader from said wireless communication device.

45. The system of claim 44, further comprising a remote system that receives communication regarding said wireless communication device from said reporting system.

46. The system of claim 26, further comprising a remote system that receives communication from said interrogation reader interrogated by said interrogation reader from said wireless communication device.

47. The system of claim 26, further comprising an gas source under control of the interrogation reader that exerts air into said plurality of panels wherein said plurality of panels each contain one or more holes to exert the gas onto the objects as the objects pass through said plurality of panels to reduce force exerted by said plurality of panels on the objects.

48. The system of claim 47, wherein said gas is comprised of air.

49. The system of claim 26, further comprising an insecticide inside said plurality of panels each containing one or more holds that exerts said insecticide onto the objects as the objects pass through said plurality of panels.

50. An interrogation system for interrogating a wireless communication device on an object, comprising:
an antenna, comprising a plurality of wedge-shaped panels attached to a mounting structure wherein each of said wedge-shaped panels contain an antenna and interlock with each other in their resting position; and
an interrogation reader coupled to said antenna to allow at least one of said plurality of panels to communicate with the wireless communication device and move about the object as it passes through said plurality of panels.

51. The system of claim 50, wherein said interrogation reader is adapted to receive communications at more than one frequency from the wireless communication device.

52. The system of claim 50, wherein said interrogation reader detects a mismatch in one of said plurality of wedge-shaped panels when the object comes into close proximity to said one of said plurality of wedge-shaped panels wherein said interrogation reader communicates with the wireless communication device on the object when said proximity sensor detects the object.

53. The system of claim 50, further comprising a proximity sensor coupled to said interrogation reader wherein said interrogation reader communicates with the wireless communication device on the object when said proximity sensor detects the object.

54. The system of claim 50, wherein at least one of said plurality of wedge-shaped panels comprises a pole antenna.

55. The system of claim 50, wherein at least one of said plurality of panels comprises a slot antenna.

56. The system of claim 54, wherein said pole antenna comprises a loop antenna.

57. The system of claim 56, wherein said loop antenna has one turn.

58. The system of claim 56, wherein said loop antenna has a plurality of turns.

59. The system of claim 56, wherein said loop antenna is comprised of a link chain.

60. The system of claim 56, wherein said loop antenna comprises more than one loop antenna.

61. The system of claim 50, wherein said plurality of wedge-shaped panels is comprised of plastic.

62. The system of claim 50, wherein said plurality of wedge-shaped panels are substantially transparent.

63. The system of claim 50, wherein said plurality of wedge-shaped panels comprises eight or more panels.

64. The system of claim 50, wherein said antenna is tuned to radiate energy at frequencies comprised from the group consisting of around about 125 kHz, around about 13.56 MHz, and around about 2.45 GHz.

65. The system of claim 50, wherein the communications received by said plurality of wedge-shaped panels from said wireless communication device are multiplexed into said interrogation reader.

66. The system of claim 50, wherein said interrogation reader communicates with said wireless communication device to obtain information about the object.

67. The system of claim 66, wherein said information is comprised from the group consisting of the object size, height, width, metal content, identification, date of manufacture, lot number, and expiration date.

68. The system of claim 50, further comprising a reporting system that receives communication from said interrogation reader interrogated by said interrogation reader from said wireless communication device.

69. The system of claim 68, further comprising a remote system that receives communication regarding said wireless communication device from said reporting system.

70. The system of claim 50, further comprising a remote system that receives communication from said interrogation reader interrogated by said interrogation reader from said wireless communication device.

71. The system of claim 50, further comprising an gas source under control of the interrogation reader that exerts air into said plurality of wedge-shaped panels wherein said plurality of wedge-shaped panels each contain one or more holes to exert the gas onto the objects as the objects pass through said plurality of wedge-shaped panels to reduce force exerted by said plurality of wedge-shaped panels on the objects.

72. The system of claim 71, wherein said gas is comprised of air.

73. The system of claim 50, further comprising an insecticide inside said plurality of wedge-shaped panels each containing one or more holds that exerts said insecticide onto the objects as the objects pass through said plurality of wedge-shaped panels.

74. A communication system, comprising:
an antenna, comprising a plurality of panels hanging from a mounting structure and capable of moving in any direction in a conical area relative to said mounting structure;
a transportation device containing at least one object containing a wireless communication device; and
an interrogation reader coupled to said antenna to allow at least one of said plurality of panels to communicate with the wireless communication device on said at least one object and move about the object as said transportation device passes through said plurality of panels.

75. The system of claim 74, wherein said transportation device is comprised from the group consisting of an assembly line, forklift truck, a crane, an automobile, and a motorcycle.

76. The system of claim 74, wherein said transportation device comprises a pallet that holds said object that contains said wireless communication device.

77. The system of claim 74, wherein said plurality of panels are capable of communicating with said wireless communication device affixed on any surface of said object.

78. The system of claim 74, wherein said at least one object is comprised from the group consisting of a container, a pallet, a beverage can, and a beer-keg.

79. The system of claim 74, wherein said interrogation reader is adapted to receive communications at more than one frequency from said wireless communication device.

80. The system of claim 74, wherein said antenna is adapted to receive communications at more than one frequency from said wireless communication device.

81. The system of claim 74, wherein said interrogation reader detects a mismatch in one of said plurality of panels when said at least one object comes into close proximity to said one of said plurality of panels wherein said interrogation reader communicates with the wireless communication device on said at least one object when said proximity sensor detects said at least one object.

82. The system of claim 74, further comprising a proximity sensor coupled to said interrogation reader wherein said interrogation reader communicates with said wireless communication device when said proximity sensor detects said object.

83. The system of claim 74, further comprising a reporting system that receives communication from said interrogation reader interrogated by said interrogation reader from said wireless communication device.

84. The system of claim 83, further comprising a remote system that receives communication regarding said wireless communication device from said reporting system.

85. The system of claim 74, further comprising a remote system that receives communication from said interrogation reader interrogated by said interrogation reader from said wireless communication device.

86. A communication system, comprising:
an antenna, comprising a plurality of wedge-shaped panels attached to a mounting structure wherein said wedge-shaped panels each contain an antenna and interlock with each other;
a transportation device containing at least one object containing a wireless communication device; and
an interrogation reader coupled to said antenna to allow at least one of said plurality of panels to communicate with the wireless communication device on said at least one object and move about the object as said transportation device passes through said plurality of panels.

87. The system of claim 86, wherein said transportation device is comprised from the group consisting of an assembly line, a forklift truck, a crane, an automobile, and a motorcycle.

88. The system of claim 86, wherein said transportation device comprises a pallet that holds said object that contains said wireless communication device.

89. The system of claim 86, wherein said plurality of wedge-shaped panels are capable of communicating with said wireless communication device affixed on any surface of said object.

90. The system of claim 86, wherein said at least one object is comprised from the group consisting of a container, a pallet, a beverage can, and a beer-keg.

91. The system of claim 86, wherein said interrogation reader is adapted to receive communications at more than one frequency from said wireless communication device.

92. The system of claim 86, wherein said antenna is adapted to receive communications at more than one frequency from said wireless communication device.

93. The system of claim 86, wherein said interrogation reader detects a mismatch in one of said plurality of wedge-shaped panels when said at least one object comes into close proximity to said one of said plurality of wedge-shaped panels wherein said interrogation reader communicates with the wireless communication device on said at least one object when said proximity sensor detects said at least one object.

94. The system of claim 86, further comprising a proximity sensor coupled to said interrogation reader wherein said interrogation reader communicates with said wireless communication device when said proximity sensor detects said object.

95. The system of claim 86, further comprising a reporting system that receives communication from said interrogation reader interrogated by said interrogation reader from said wireless communication device.

96. The system of claim 95, further comprising a remote system that receives communication regarding said wireless communication device from said reporting system.

97. The system of claim 86, further comprising a remote system that receives communication from said interrogation reader interrogated by said interrogation reader from said wireless communication device.

98. A communication system, comprising:
an antenna, comprising a plurality of wedge-shaped panels attached to said mounting structure wherein each of said plurality of wedge-shaped panels contain an antenna and are interlocked with each other in their resting position;
an object containing a wireless communication device; and
an interrogation reader coupled to said antenna to allow at least one of said plurality of panels to communicate with the wireless communication device on the object and move about the object as said antenna moves through the object.

99. A method of constructing a curtain antenna that is capable of communicating with a wireless communication device on an object that passes through the antenna, comprising the steps of:
placing an antenna inside each of a plurality of panels; and
attaching said plurality of panels to a horizontal mounting structure so that said panels hang down from said mounting structure and so that each of said plurality of panels is capable of moving in any direction in a conical area relative to said mounting structure.

100. The method of claim 99, wherein said placing comprises placing a plurality of loop antennas inside each of said plurality of panels.

101. The method of claim 99, further comprising attaching said horizontal mounting structure on a transportation device.

102. The method of claim 99, further comprising coupling said plurality of panels to an interrogation reader.

103. The method of claim 99, wherein said placing comprises placing a loop antenna with more than one turn inside each of said plurality of panels.

104. The method of claim 103, further comprising a reporting system that receives communication from said interrogation reader interrogated by said interrogation reader from said wireless communication device.

105. The method of claim 104, further comprising a remote system that receives communication regarding said wireless communication device from said reporting system.

106. The method of claim 102, further comprising a remote system that receives communication from said interrogation reader interrogated by said interrogation reader from said wireless communication device.

107. A method of constructing a curtain antenna that is capable of communicating with a wireless communication device on an object that passes through the antenna, comprising the steps of:
placing an antenna inside each of a plurality of wedge-shaped panels; and
attaching said wedge-shaped plurality of panels to a mounting structure so that said panels interlock with each other in their resting position so that each of said plurality of wedge-shaped panels is capable of moving about the object as it passes through said mounting structure.

108. The method of claim 107, wherein said placing comprises placing a plurality of loop antennas inside each of said plurality of wedge-shaped panels.

109. The method of claim 107, further comprising attaching said mounting structure on a transportation device.

110. The method of claim 107, further comprising coupling said plurality of wedge-shaped panels to an interrogation reader.

111. The method of claim 107, wherein said placing comprises placing a loop antenna with more than one turn inside each of said plurality of wedge-shaped panels.

112. A method of communicating with a wireless communication device on an object, comprising:
passing the object through an antenna comprised of a plurality of panels hanging from a horizontal mounting structure wherein said plurality of panels are capable of moving about the object in any direction in a conical area relative to said mounting structure; and
interrogating the wireless communication device on the object as the object passes through said plurality of panels.

113. The method of claim 112, wherein said interrogating comprises interrogating at more than one frequency to communicate with the wireless communication device.

114. The method of claim 112, further comprising sensing the object before interrogating the wireless communication device on the object.

115. The method of claim 112, further comprising multiplexing communications received by said plurality of panels from the wireless communication device.

116. The method of claim 112, further comprising exerting a gas onto the object as it passes through said plurality of panels to reduce the force exerted by said plurality of panels on the object.

117. The method of claim 112, further comprising exerting an insecticide onto the object as it passes through said plurality of panels to protect the object from insects.

118. A method of communicating with a wireless communication device on an object, comprising:
passing the object through an antenna comprised of a plurality of wedge-shaped panels attached to a mounting structure that interlock with each other in their resting position wherein said panels are capable of moving about the object as the object passes through said plurality of wedge-shaped panels; and
interrogating the wireless communication device on the object as the object passes through said plurality of wedge-shaped panels.

119. The method of claim 118, wherein said interrogating comprises interrogating at more than one frequency to communicate with the wireless communication device.

120. The method of claim 118, further comprising sensing the object before interrogating the wireless communication device on the object.

121. The method of claim 118, further comprising multiplexing communications received by said plurality of wedge-shaped panels from the wireless communication device.

122. The method of claim 1 18, further comprising reporting information about said wireless communication device interrogated by said interrogation reader to a reporting system.

123. The method of claim 122, further comprising reporting said information from said reporting system to a remote system.

124. The method of claim 118, further comprising reporting information about said wireless communication device interrogated by said interrogation reader to a remote system.

125. The method of claim 118, further comprising exerting a gas onto the object as it passes through said plurality of wedge-shaped panels to reduce the force exerted by said plurality of wedge-shaped panels on the object.

126. The method of claim 118, further comprising exerting an insecticide onto the object as it passes through said plurality of wedge-shaped panels to protect the object from insects.

127. A method of communicating with a wireless communication device on an object, comprising:
passing an antenna that is comprised of a plurality of panels hanging from a horizontal mounting structure through the object wherein said plurality of panels are capable of moving about the object in any direction in a conical area relative to said mounting structure; and
interrogating the wireless communication device on the object as said plurality of panels moves through the object.

128. The method of claim 127, further comprising sensing the object before interrogating the wireless communication device on the object.

129. The method of claim 127, further comprising multiplexing communications received by said plurality of panels from the wireless communication device.

130. The method of claim 127, further comprising reporting information about said wireless communication device interrogated by said interrogation reader to a reporting system.

131. The method of claim 130, further comprising reporting said information from said reporting system to a remote system.

132. The method of claim 127, further comprising reporting information about said wireless communication device interrogated by said interrogation reader to a remote system.

133. The method of claim 127, further comprising exerting a gas onto the object as it passes through said plurality of panels to reduce the force exerted by said plurality of panels on the object.

134. The method of claim 127, further comprising exerting an insecticide onto the object as it passes through said plurality of panels to protect the object from insects.

135. A method of communicating with a wireless communication device on an object, comprising:
passing an antenna that is comprised of a plurality of wedge-shaped panels attached to a mounting structure that interlock with each other in their resting position wherein said plurality of wedge-shaped panels are capable of moving about the object as the object passes through said plurality of wedge-shaped panels; and
interrogating the wireless communication device on the object as said plurality of panels moves through the object.

136. The method of claim 135, further comprising sensing the object before interrogating the wireless communication device on the object.

137. The method of claim 135, further comprising multiplexing communications received by said plurality of wedge-shaped panels from the wireless communication device.

138. The method of claim 135, further comprising reporting information about said wireless communication device interrogated by said interrogation reader to a reporting system.

139. The method of claim 138, further comprising reporting said information from said reporting system to a remote system.

140. The method of claim 135, further comprising reporting information about said wireless communication device interrogated by said interrogation reader to a remote system.

141. The method of claim 135, further comprising exerting a gas onto the object as it passes through said plurality of wedge-shaped panels to reduce the force exerted by said plurality of wedge-shaped panels on the object.

142. The method of claim 135, further comprising exerting an insecticide onto the object as it passes through said plurality of wedge-shaped panels to protect the object from insects.
